(19) United States
(12) Patent Application Publication
(10) Pub. No.: US 2005/0128513 A1
(43) Pub. Date: Jun. 16, 2005

(54) Spool control device and method for efficiently performing multiple print jobs

(75) Inventor: Seung-jin Cho, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/000,923

(22) Filed: Dec. 2, 2004

(30) Foreign Application Priority Data
Dec. 15, 2003 (KR) 2003-91524

(51) Int. Cl. G06F 15/00

(52) U.S. Cl. 358/1.15; 358/1.9

(57) ABSTRACT

A spool control device and method for efficiently performing multiple print jobs. The spool control device includes a print-job processing unit for generating a plurality of print jobs and sending print commands to have the print jobs performed; an interface unit having a plurality of ports connected to printers for sending the print jobs to the printers through the plurality of ports; and a spool unit for storing the print jobs in the order that printing is to be performed, reading out the stored print jobs in a FIFO manner, and allocating the read print jobs to the ports, respectively.

### PRIORITY

This application claims priority under 35 U.S.C. § 119(a) to an application entitled “Spool Control Device And Method For Efficiently Performing Multiple Jobs”, filed in the Korean Intellectual Property Office on Dec. 15, 2003 and assigned Serial No. 2003-91524, the entire contents of which are incorporated herein by reference.

### BACKGROUND OF THE INVENTION

1. Field of the Invention

The present invention relates generally to a spool control device for printers. More particularly, the present invention relates to a spool control device and method of use for effectively performing plural print jobs through the use of available ports when the plural print jobs are required.

2. Description of the Related Art

In general, if a user sends a print command to a host computer, the printer driver installed in the host computer has the host computer print the documents that the user has prepared. The printer driver includes a program module typically supplied by printer makers for converting graphics data written in an application into printer data that a printer can recognize. For example, PostScript printer drivers convert various drawings, images, and characters written in an application into the PostScript language format. Still others, such as Printer Command Language (PCL) printer drivers, convert various drawings, images and characters into the PCL language format.

Spoolers are then provided to stack a queue for printing the converted printer data in order, and sending the data to a corresponding printer through an allocated output port in a First-In, First-Out (FIFO) manner.

FIG. 1 is a flowchart illustrating an example of a conventional spooling process for printing multiple documents through print jobs, such as Job1, Job2, and Job3. As shown in FIG. 1, a user can prepare multiple documents in an application at step S11, and send print commands for the prepared documents in turn, at step S13. A spooler determines whether an allocated output port is available at step S15. If available, the spooler stacks the print jobs such as, for example, Job1, Job2, and Job3 to queue the documents in order. The spooler then sends the document data to the printer through the allocated output port in order at step S17. However, if the allocated output port is not available, the spooler displays a retry message at step S19.

As noted above, the print jobs Job1, Job2, and Job3 for the document, which are stacked to the queue of the spooler, are sent in order through the allocated output port. That is, the print jobs Job1, Job2, and Job3 are sent in an order such that, if the print job Job1 for one document has been completely performed, then the print job Job2 for another document is sent. If the print job Job2 has been completely performed, then the print job Job3 for the other document is sent. Therefore, in circumstances where a plurality of documents are to be printed, the conventional spooling process printing efficiency is deteriorated since the documents are sent through only one allocated output port, even though several output ports such as a parallel port, USB port, and Network port are available.

Accordingly, a need exists for a spool control device and method for printers which can efficiently allocate multiple print jobs to all available ports in circumstances where multiple print jobs are to be performed.

### SUMMARY OF THE INVENTION

It is therefore an object of the present invention to solve the above drawbacks and other problems associated with conventional printing arrangements. An aspect of the present invention is to provide a spool control device and method for printers for allocating multiple print jobs to multiple ports (such as all available ports) in circumstances where multiple print jobs are to be performed.

These and other objects and advantages are substantially achieved by providing a spool control device for spooling and sending print jobs from user terminals to printers. The spool control device includes a print-job processing unit for generating a plurality of print jobs and sending print commands to have the print jobs performed; an interface unit having a plurality of ports connected to printers for sending the print jobs to the printers through the plurality of ports; and a spool unit for storing the plurality of print jobs in the order that printing is to be performed, reading out the stored print jobs in a First-In, First-Out (FIFO) manner, and allocating the read print jobs to the ports, respectively.

Preferably, the spool control device further includes a printer drive unit for converting documents of the plurality of print jobs into printer data that the printers can recognize.

The spool unit includes a storage unit for storing the plurality of the print jobs in the order that printing is to be performed; a spool controller for reading out the plurality of the print jobs stored in the storage unit in the FIFO manner, and allocating the read print jobs to the ports; and a port monitor for monitoring the ports in real time. The spool controller of the spool unit then allocates the read print jobs to available ports based on a monitoring result.

More preferably, the spool controller assigns a priority order to the available ports and allocates the read print jobs to the available ports based upon this priority order, respectively.

According to another aspect of the present invention, a spool control method is provided for spooling and sending print jobs from user terminals to printers. The method includes the steps of (a) generating the plurality of print jobs and sending print commands to have the print jobs performed; and (b) storing the plurality of print jobs in the order that printing is to be performed, reading out the stored print jobs in a First-In, First-Out manner, and allocating the read print jobs to the ports connected to printers, respectively.

Preferably, the spool control method further includes the step of converting documents of the print jobs into printer data that the printers can recognize.

The above step (b), further includes the steps of (b-1) storing the plurality of print jobs in the order that printing is to be performed, (b-2) monitoring the ports and determining which of the ports are available, and (b-3) allocating print jobs, read in the FIFO manner, out of the stored print jobs and to the available ports.

More preferably, the above step (b-3) assigns a priority order to the available ports, and allocates the read print jobs to the available ports according to the priority order, respectively.

Accordingly, embodiments of the present invention can be applied to enhance print efficiency by allocating multiple print jobs to several printers through the use of all available ports, such as a parallel port, USB port, and network port, in circumstances where the print jobs are consecutively performed.

### BRIEF DESCRIPTION OF THE DRAWINGS

The above aspects and features of the present invention will become more apparent by describing certain embodiments of the present invention with reference to the accompanying drawing figures, in which:

FIG. 1 is a flowchart illustrating a conventional spooling process for performing multiple print jobs;

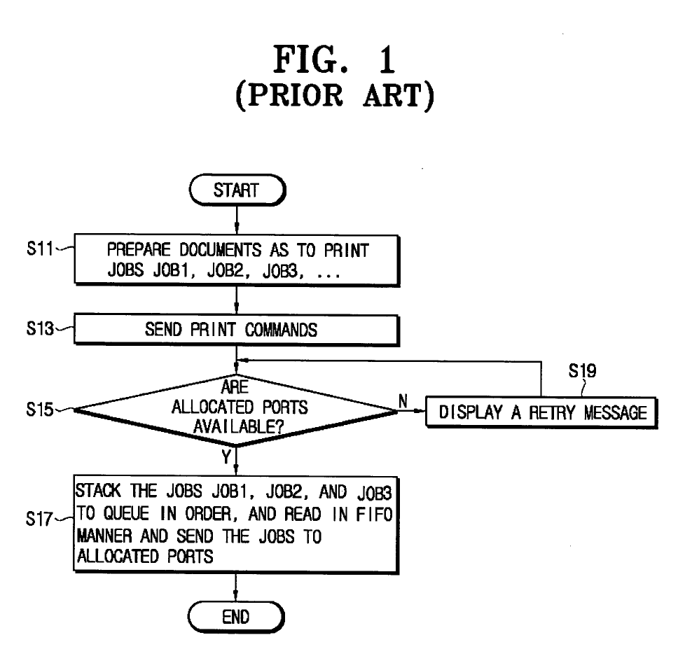

FIG. 2 is a block diagram illustrating a host computer containing a spool control device according to an embodiment of the present invention;

FIG. 3 is a detailed block diagram illustrating a spool control device according to an embodiment of the present invention; and

FIG. 4 is a flowchart illustrating a spool control process for performing multiple print jobs according to an embodiment of the present invention.

### DETAILED DESCRIPTION OF THE EXEMPLARY EMBODIMENTS

Hereinafter, the embodiments of the present invention will be described in detail with reference to the accompanying drawing figures.

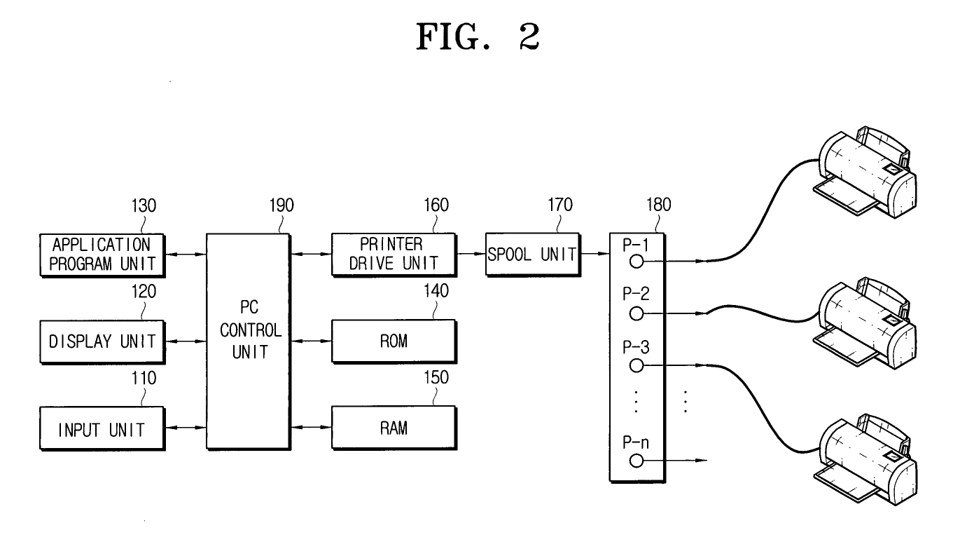

FIG. 2 is a block diagram illustrating an example host computer including a spool control device for efficiently printing multiple documents according to an embodiment of the present invention.

The host computer and spool control device of FIG. 2 has an input unit 110, a display unit 120, an application program unit 130, a read only memory (ROM) 140, a random access memory (RAM) 150, a printer drive unit 160, a spool unit 170, an input/output (I/O) interface 180, and a personal computer (PC) control unit 190.

The input unit 110 receives operation commands from users via any number of devices, such as a keyboard or a mouse.

The display unit 120 externally displays the operation states of a host computer via a device, such as a monitor.

The application program unit 130 stores diverse application programs designed to have specific functions directly performed for users. For example, the application programs can include word processors, database programs, web browsers, development tools, image edit programs, and communication programs.

The ROM 140 includes a nonvolatile memory device, and stores various control programs based on program executions of the PC control unit 190.

The RAM 150 includes a volatile memory device, and temporarily stores data based on program executions of the PC control unit 190.

The printer drive unit 160 includes software to execute various jobs associated with document outputs between the host computer and a printer, and includes information on printer functions, fonts, and various commands. That is, the printer drive unit 160 converts documents to be printed into printer data that a printer can recognize using any number of application programs. According to an embodiment of the present invention, documents are converted into printer data, such as PCL data, that a plurality of printers connected to a plurality of ports, such as a parallel port, a USB port, and a network port, can recognize.

The spool unit 170 stacks printer data to queue print jobs in the order processed in the printer drive unit 160, reads out the print jobs in the FIFO manner, and provides the read print jobs to the I/O interface unit 180.

The I/O interface unit 180 has a plurality of ports P-1, P-2, . . . , through P-n, and wherein some ports, such as P-1, P-2, and P-3 are connected to corresponding printers, respectively. The spool unit 170 checks the I/O interface 180 to find out which of the ports P-1, P-2, and P-3 are currently available, and selects available ports. The spool unit 170 can then allocate print jobs read out of the queue to the selected ports. The ports can be allocated according to an established priority order.

The PC control unit 190 controls the overall operations of the host computer based on the programs stored in the ROM 140.

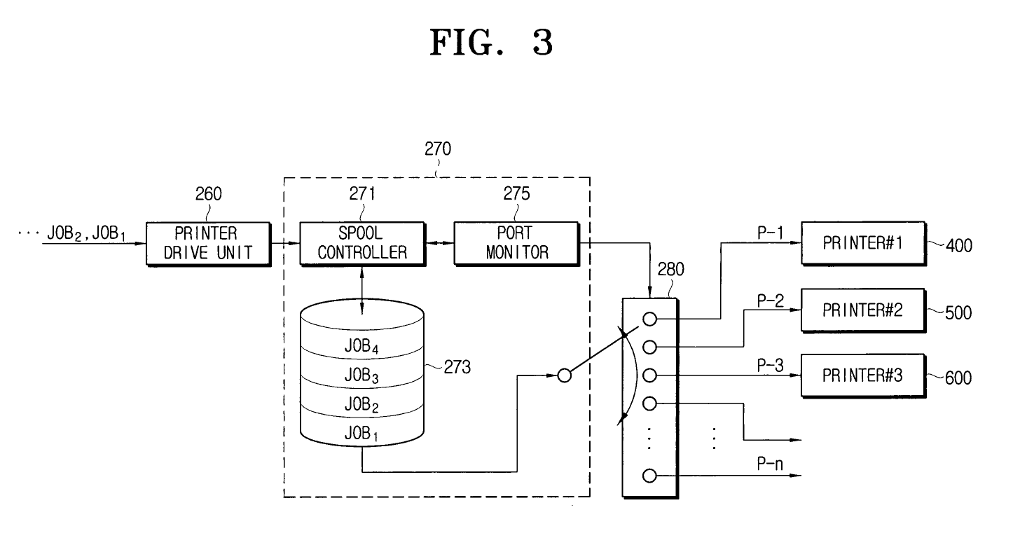

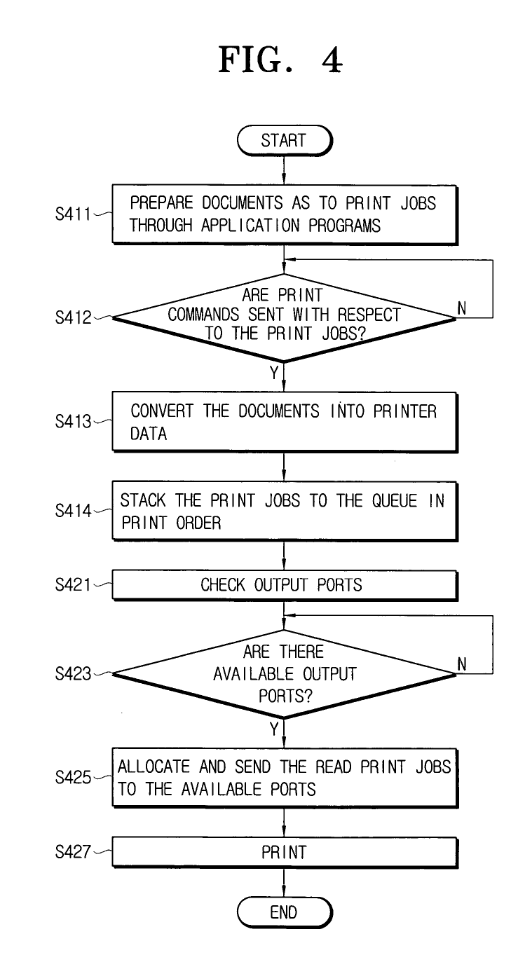

FIG. 3 is a detailed block diagram illustrating an example of the spool control device of FIG. 2 for efficiently processing multiple print jobs according to an embodiment of the present invention. FIG. 4 is a flowchart illustrating a spool control process for the multiple print jobs. Hereinafter, the spool control process will be described in more detail with reference to both FIGS. 3 and 4.

As illustrated in the flowchart of FIG. 4, a user first prepares a plurality of documents (hereinafter referred to as ‘print jobs’) through application programs at step S411, and sends print commands for the prepared documents to establish print jobs at step S412.

The documents to be printed are converted into printer data by a printer drive unit 260 for output as print jobs, such as Job1, Job2, Job3, and Job4, at step S413. The data of print jobs Job1, Job2, Job3, and Job4 for the printer are then input to a spool device 270 in print order.

As shown in FIG. 3, the spool device 270 has a spool controller 271, a queue 273, and a port monitor 275.

The spool controller 271 stores the print jobs Job1, Job2, Job3, and Job4 into the queue 273 in the order that printing is to be performed at step S414.

The port monitor 275 monitors the ports of an I/O interface unit 280 in real time.

Based upon the monitored status of the I/O interface unit 280, the port monitor 275 selects available ports from the plurality of ports P-1, P-2, . . . , through P-n of the I/O interface unit 280 at step S421. The available ports are ports connected to printers, and in the example shown in FIG. 3, ports P-1, P-2, and P-3 are connected to printers 400, 500, and 600, respectively.

The port monitor 275 monitors the selected ports P-1, P-2, and P-3 in real time, and determines which of the ports P-1, P-2, and P-3 are available at step S423.

The port monitor 275 provides the spool controller 271 with information on the available ports based on a result of the determination, and the spool controller 271 allocates to the available ports print jobs read in the FIFO manner out of the queue 273 at step S425.

Accordingly, the printers connected to the available ports can then perform the print jobs that have been read out at step S427.

For example, if a print job is sent to the current port P-1 as a result of the monitoring of the I/O interface unit 280 by the port monitor 275, the spool controller 271 will detect P-1 is unavailable, and sets the priority order as “(P-2)>(P-3)” with respect to the ports P-2 and P-3, and allocates the print jobs Job1 and Job2 read out of the queue 273 to the ports P-2 and P-3 according to the set priority order. That is, the spool controller 271 allocates and sends the print job Job1 to the port P-2, and the print job Job2 to the port P-3.

The port monitor 275 keeps monitoring the ports P-1, P-2, and P-3 while the above print jobs Job1 and Job2 are being sent through the ports P-2 and P-3. If the port P-1 becomes available while the print jobs Job1 and Job2 are being sent through the ports P-2 and P-3, the spool controller 271 allocates and sends the read print job Job3 to the port P-1, since the port P-1 is now available.

That is, the spool controller allocates print jobs read out of the queue 273 to available ports based on a result of the real-time monitoring of the port monitor 275.

Accordingly, embodiments of the present invention described above allocate and send multiple print jobs to available ports in order for printers connected to the ports to perform printing, which can enhance print efficiency as opposed to prior art techniques which perform multiple print jobs through the use of one port only.

Embodiments of the present invention advantageously allow multiple print jobs to be performed at the same time by allocating and sending the print jobs to all available ports such as the parallel port, the USB port, and the network port, in circumstances where the print jobs are to be consecutively processed, thereby enhancing printing efficiency.

The foregoing embodiments and advantages are merely exemplary and are not to be construed as limiting the present invention. The present teaching can be readily applied to other types of apparatus. Also, the description of the embodiments of the present invention is intended to be illustrative, and not to limit the scope of the claims, and many alternatives, modifications, and variations will be apparent to those skilled in the art.

1. A spool control device for spooling and sending print jobs from user terminals to printers, comprising:
a print-job processing unit for generating a plurality of print jobs and sending print commands to have the print jobs performed;
an interface unit having a plurality of ports connected to a plurality of printers for sending the print jobs to the plurality of printers through the plurality of ports; and
a spool unit for storing the plurality of print jobs in an order that printing is to be performed, reading out the stored plurality of print jobs, and allocating the read print jobs to the plurality of ports.

2. The spool control device as claimed in claim 1, further comprising a printer drive unit for converting documents of the plurality of print jobs into printer data that the plurality of printers can recognize.

3. The spool control device as claimed in claim 1, wherein the print-job process unit further comprises at least one diverse application program, the program provided to generate documents for the plurality of print jobs, and send print commands with respect to the documents.

4. The spool control device as claimed in claim 1, wherein the spool unit comprises:
a storage unit for storing the plurality of the print jobs in the order that printing is to be performed;
a spool controller for reading out the plurality of the print jobs stored in the storage unit and allocating the read print jobs to the plurality of ports; and
a port monitor for monitoring the plurality of ports in real time, wherein the spool controller allocates the read print jobs to available ports of the plurality of ports based on a monitoring result.

5. The spool control device as claimed in claim 4, wherein the spool controller assigns a priority order to the available ports and allocates the read print jobs to the available ports according to the priority order.

6. A spool control method for spooling and sending print jobs from user terminals to printers, comprising:
(a) generating a plurality of print jobs and sending print commands to perform the print jobs; and
(b) storing the plurality of the print jobs in an order that printing is to be performed, reading out the stored print jobs, and allocating the read print jobs to a plurality of ports connected to a plurality of printers.

7. The spool control method as claimed in claim 6, further comprising converting documents of the plurality of print jobs into printer data that the plurality of printers can recognize.

8. The spool control method as claimed in claim 6, wherein the step (a) further comprises at least one diverse application program, the program provided to generate documents for the plurality of print jobs, and send print commands with respect to the documents.

9. The spool control method as claimed in claim 6, wherein the step (b) further comprises:
(b-1) storing the plurality of the print jobs in the order that printing is to be performed;
(b-2) monitoring the plurality of ports and determining which of the ports are available; and
(b-3) allocating print jobs out of the stored print jobs to the available ports.

10. The spool control method as claimed in claim 9, wherein the step (b-3) further comprises assigning a priority order to the available ports, and allocating the read print jobs to the available ports according to the priority order.

11. The spool control device as claimed in claim 1, wherein the spool unit reads out the stored plurality of print jobs in a First-In, First-Out (FIFO) manner.

12. The spool control device as claimed in claim 4, wherein the spool controller reads out the plurality of the print jobs stored in the storage unit in a FIFO manner.

13. The spool control method as claimed in claim 6, wherein the step (b) further comprises reading out the stored print jobs in a FIFO manner.

14. The spool control method as claimed in claim 9, wherein the step (b-3) further comprises allocating print jobs read in a FIFO manner out of the stored print jobs to the available ports.
